(19) United States
(12) Patent Application Publication
(10) Pub. No.: US 2003/0236706 A1
(43) Pub. Date: Dec. 25, 2003

(54) System and method for providing a third party originating item to a passenger on a commercial airliner

(76) Inventor: Jeffrey Weiss, Potomac, MD (US)

Correspondence Address: WEISS & MOY PC, 4204 NORTH BROWN AVENUE, SCOTTSDALE, AZ, 85251, US

(21) Appl. No.: 10/175,810

(22) Filed: Jun. 21, 2002

(51) Int. Cl. G06F 17/60

(52) U.S. Cl. 705/15

(57) ABSTRACT

A method and system for providing items from a third party (i.e., non-airline) source to a passenger travelling on a commercial airliner. An air traveler orders an a third-party originating item from an ordering location and provides sufficient identifying information to permit later delivery, the item is prepared at a preparation facility, the item is then delivered to the airliner on which the air traveler is to travel, and the item is then provided to the air traveler at the airliner. Preferably, the air traveler makes payment for the item at the time of ordering. In the preferred embodiment, the item is a coffee-type drink.

### FIELD OF THE INVENTION

This invention relates generally to methods and systems for providing items from a third party (i.e., non-airline) source to a passenger travelling on a commercial airliner and, more particularly and in a preferred embodiment, to a method and system for providing an off-site (i.e., off-airliner) prepared coffee-type drink to a passenger located on a commercial airliner.

### BACKGROUND OF THE INVENTION

Custom-prepared coffee-type drinks are increasingly popular in today's world. Coffees, espressos, lattes, hot chocolates, mochas, and others are examples of the kinds of drinks that large numbers of people purchase in cafes or the like at the beginning of a typical day. Starbucks® is an example of a particularly successful chain of cafes that provide a large variety of coffee-type drinks and that caters to this type of consumer. Other known preparers of coffee-type drinks include Dunkin Donuts®, Seattle's Best®, and The Coffee Plantation®, among others.

A class of consumer that would generally be expected to desire to partake of a coffee-type drink from a café is the commercial air traveler. Particularly where an individual needs to travel in the early part of a day, the desire for a coffee-type drink can be strong. However, a number of obstacles can get in the way of an air traveler who wishes to enjoy a custom-prepared coffee-type drink.

If the air traveler lacks time to stop at a cafe before heading to the airport, or if the terminal lacks a café, he or she will be unable to purchase the desired coffee-type drink before travelling. Or, even if he or she is able to purchase a drink at a cafe, the air traveler may finish the drink and be desirous of ordering another by the time he or she boards the plane and is ready to depart. Still further, if the air traveler waits until he or she is on the plane, the only option will be to obtain a plain cup of coffee from the plane's in-flight beverage service. For obvious logistics reasons—including limitations on preparation time and the lack of sophisticated brewing equipment—in-flight beverage services have not offered the full range of coffee-type drinks, including lattes, espressos and the like.

A need therefore existed for a method and system that permits an air traveler on a commercial airliner to be provided a specialized coffee-type drink that has been prepared off-site (i.e., remote from the airplane on which the air traveler is to travel). The system and method should not require the in-flight server to be responsible for preparation of the coffee-type drink. The system and method should provide the air traveler with the ability to be provided, while seated on a commercial airliner, a coffee-type drink of a type that cannot be provided by prior art in-flight service methods and systems, such as a latte or espresso. The system and method should permit the convenient ordering of such a coffee-type drink by an air traveler, by providing an ordering facility in the airport terminal (in the form of a coffee shop, stand, kiosk, waiter or otherwise), or by permitting the ordering of a coffee-type drink over the Internet prior to travel. The system and method should further provide for the efficient delivery of the coffee-type drink to the commercial airliner, together with sufficient identifying information concerning the air traveler so as to facilitate ready delivery of the drink to the air traveler located on the commercial airliner. And the system and method should be capable of being adapted for use with other items originating from a non-airline source, such as food items, office supplies, clothing, reading materials, information, and the like. The present invention satisfies these needs and provides other, related, advantages.

### SUMMARY OF THE INVENTION

It is an object of the present invention to provide a system and method for providing a commercial air traveler with a specialized coffee-type drink, such as a latte or espresso.

It is a further object of the present invention to provide a system and method for providing a commercial air traveler with a specialized coffee-type drink, wherein the drink is prepared at a location that is remote relative to the airplane upon which the commercial air traveler travels.

It is a still further object of the present invention to provide a system and method for providing a commercial air traveler with a specialized coffee-type drink, which permits the convenient ordering of such a coffee-type drink by an air traveler prior to boarding a commercial airliner, by providing an ordering facility in the airport terminal (in the form of a coffee shop, stand, kiosk, waiter or otherwise), or by permitting the ordering of a coffee-type drink over the Internet.

It is a yet further object of the present invention to provide a system and method for providing a commercial air traveler with a specialized coffee-type drink, which provides for the efficient delivery of the coffee-type drink to the commercial airliner, together with sufficient identifying information concerning the air traveler so as to facilitate ready delivery of the drink to the air traveler located on the commercial airliner.

It is a further object of the present invention to provide a system and method for providing other items originating from a non-airline source, such as food items, office supplies, clothing, reading materials, information, and the like, to an air traveler located on a commercial airliner, where such items are ordered prior to boarding the commercial airliner.

### BRIEF DESCRIPTION OF THE PREFERRED EMBODIMENTS

In accordance with one embodiment of the present invention, a method for providing a coffee-type drink to an air traveler on a commercial airliner is disclosed. The method comprises the steps of: an air traveler, prior to boarding a commercial airliner, ordering a coffee-type drink from an ordering location; the air traveler providing to the ordering location identifying information regarding the air traveler; communicating the order for the coffee-type drink to a remote coffee-type drink preparation facility; preparing the coffee-type drink in accordance with the order at the coffee-type drink preparation facility; applying the identifying information to the coffee-type drink; delivering the coffee-type drink from the preparation facility to the commercial airliner; and delivering the coffee-type drink to the air traveler at the commercial airliner.

In accordance with another embodiment of the present invention, a coffee-drink preparation and delivery system is disclosed. The system comprises, in combination: a coffee-type drink preparation facility; wherein the coffee-type drink preparation facility is remote from a commercial airliner; an ordering location where an air traveler can order a coffee-type drink prior to boarding the commercial airliner and provide identifying information regarding the air traveler; wherein the ordering location and the preparation facility are in communication with one another; a first delivery mechanism for delivering coffee-type drink prepared at the preparation facility to the commercial airliner; and a second delivery mechanism for delivering the coffee-type drink prepared at the preparation facility and delivered to the commercial airliner to the air traveler.

In accordance with yet another embodiment of the present invention, a method for providing a third-party originating item to an air traveler on a commercial airliner is disclosed. The method comprises the steps of: an air traveler, prior to boarding a commercial airliner, ordering a third-party originating item from an ordering location; the air traveler providing to the ordering location identifying information regarding the air traveler; communicating the order for the third-party originating item to a remote third-party originating item preparation facility; providing the third-party originating item in accordance with the order at the preparation facility; applying the identifying information to the third-party originating item; delivering the third-party originating item from the preparation facility to the commercial airliner; and delivering the third-party originating item to the air traveler at the commercial airliner.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a block-type diagram, illustrating the components of a system, consistent with the present invention, for providing an off-site prepared coffee-type drink to an air traveler.

FIG. 2 is a flow-chart, illustrating a method, consistent with the present invention, for providing an off-site prepared coffee-type drink to an air traveler.

FIG. 3 is a block-type diagram, illustrating the components of a system, consistent with the present invention, for providing an item originating from a third party source to an air traveler on a commercial airliner.

FIG. 4 is a flow chart illustrating a method, consistent with the present invention, for providing an item originating from a third party source to an air traveler on a commercial airliner.

### DETAILED DESCRIPTION OF THE PREFERRED EMBODIMENTS

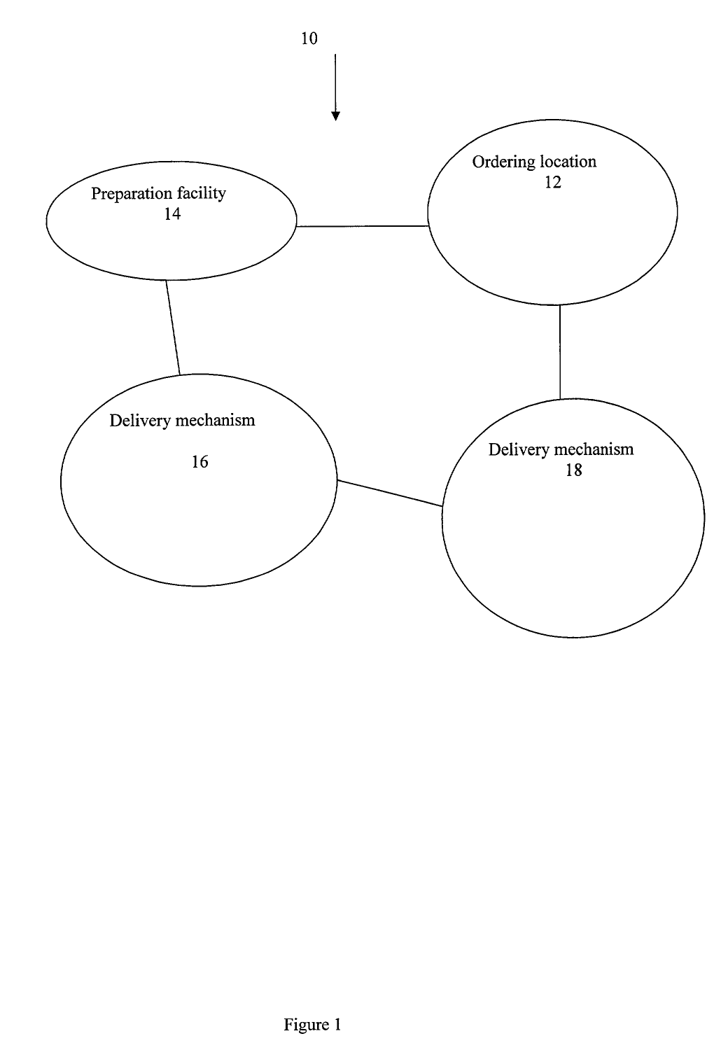

Referring first to FIG. 1, the main components of a system 10, consistent with the present invention, for providing an off-site prepared coffee-type drink to an air traveler is shown. These include an ordering location 12, where an air traveler can place an order for a coffee-type drink; a remote preparation facility 14; a delivery mechanism 16 for delivering a coffee-type drink from the remote preparation facility 14 to a commercial airliner; and a delivery mechanism 18 for delivering a coffee-type drink on the commercial airliner to a specific air traveler.

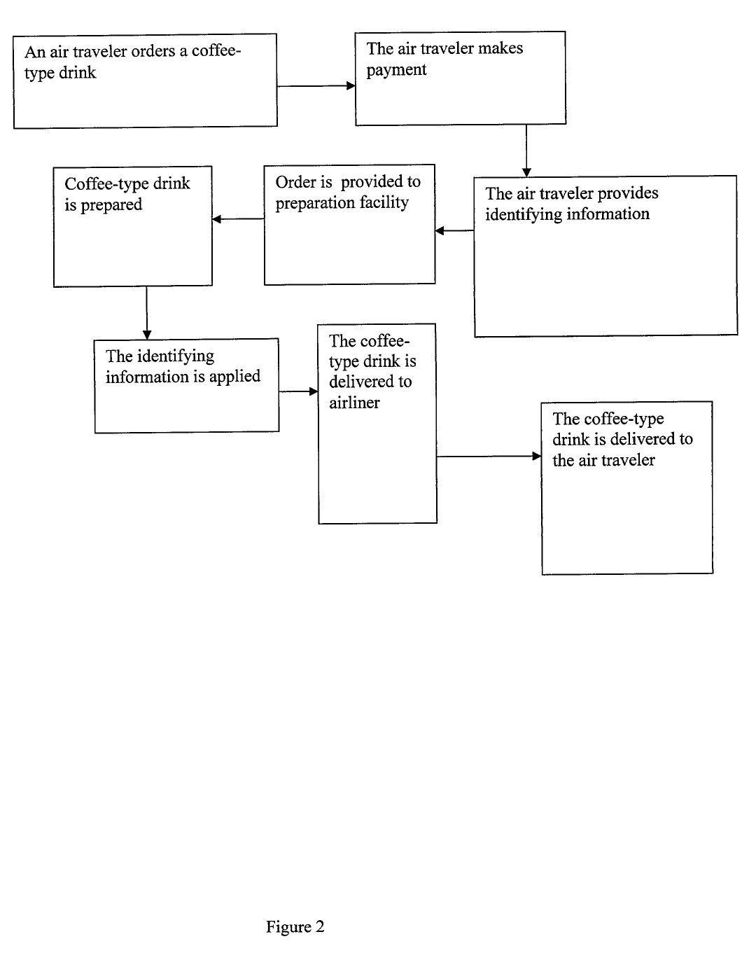

Referring now to FIG. 2, a flow chart illustrating an embodiment of a method consistent with the present invention is shown. A description of the method of FIG. 2 will further clarify the components of the system 10 of the present invention. The first step in the method shown in FIG. 2 is the placement by the air traveler of an order with an ordering location 12, prior to the boarding of a commercial airliner, for a coffee-type drink. Preferably, at the same time, the air traveler will also make payment to the ordering location 12 for the coffee-type drink. It would be possible, however, for payment to be made by the air traveler at the time the coffee-type drink is delivered to the air traveler on the commercial airliner. Still further, it should be noted that, except as specifically claimed herein, it would be possible for the airline rather than the air traveler to make payment for the coffee-type drink.

The air traveler will provide the ordering location 12 with sufficient identifying information so that the coffee-type drink can later, as described in more detail below, be delivered to the air traveler on a commercial airliner. The identifying information will likely include, at a minimum, the air traveler's name. Preferably, it will further include the identity of the airline upon which the air traveler is to be travelling, the number of the air traveler's flight, and perhaps still further information such as the air traveler's seat assignment, gate assignment for the flight, etc.

The ordering location 12 can be the physical location where the coffee-type drink is to be physically prepared, i.e., the remote coffee-type drink preparation facility 14. For example, the ordering location 12 can be a coffee shop located in an airport facility, and which an air traveler may visit prior to boarding a commercial flight to place an order for a coffee-type drink. It is also possible that the ordering location 12 may be remote from the preparation facility. Thus, for example, the ordering location 12 may be a stand in an airport terminal that accepts orders for a coffee-type drink and payment therefor, and that then transmits those orders to the preparation facility 14. The ordering location 12 may be an individual, such as a waiter, who passes through a terminal, preferably in an identifying uniform of some type, collecting orders for coffee-type drinks and then transmitting them in appropriate fashion to the preparation facility 14 (e.g., by physically delivering the orders, by electronically transmitting the orders, or otherwise).

Yet further, the ordering location may be a web-site in communication with the preparation facility 14, where drink orders and preferably payments are received and from where orders may be communicated to the preparation facility 14. (Where the preparation facility 14 is owned by an entity other than the commercial airline, it will be preferred that the web-site be maintained by that entity.) The ordering location 12 could also be a kiosk or the like having a personal computer or the like located therein, and where an air traveler may place an order for a coffee-type drink and which order may then be transmitted electronically to the preparation facility 14.

Still further, the ordering location 12 may be an airline check-in staff member, who will take the order, perhaps also process payment, and communicate the order to the preparation facility 14. Where the ordering location is provided by the airline, ordering can be accomplished in-person, by telephone, or electronically via an electronic communication to an airline web-site.

The preparation facility 14 is the location where the coffee-type drink is physically prepared. It should be located in sufficient proximity to the commercial airliner so that a drink can be prepared and delivered, in a fresh and hot (or fresh and cold for a cold beverage) state to the airliner. Preferably, the preparation facility 14 will be located in the airport, and preferably in one or more terminals. The preparation facility 14 can be a coffee shop where walk-up customers can purchase coffee-type drinks and perhaps other items for immediate consumption, or it could be a production facility that does not also accept walk-up business. Some combination of these is also possible.

In accordance with the order received, the coffee-type drink will be prepared at the preparation facility 14. Additionally, the identifying information previously supplied by the air traveler will be coupled to the coffee-type drink in appropriate manner, so as to facilitate delivery (discussed below) of the prepared coffee-type drink first to the airliner and later to the air traveler on the airliner. Preferably, this will be accomplished by placing the identifying information directly on the container of the coffee-type drink, by either handwriting it onto the container, or perhaps by writing or printing it onto a sticker that is later applied to the container. It may also be accomplished in other ways, for example by placing the prepared coffee-type drink in an appropriate portion of a container/carrier, wherein identifying information is located on a wall, surface, or other portion of each such section, and where perhaps an entire multi-section container/carrier is dedicated to a single flight, gate, airline, or other classification.

Once the coffee-type drink is prepared and the identifying information is applied in appropriate manner, it will be necessary to deliver the coffee-type drink from the preparation facility 14 to the commercial airliner on which the air traveler is to travel. It would be possible, for example, for a person associated with the preparation facility 14, or with the commercial airliner, to hand carry one or more prepared coffee-type drinks from the preparation facility 14 to the commercial airliner. To promote efficiency, it would be preferred for a plurality of coffee-type drinks associated with a particular flight leaving from a particular gate, or associated with a particular section of a terminal, or otherwise grouped to promote delivering efficiency, to be positioned in a multi-sectioned drink container/carrier and then delivered to the commercial airliner.

Once the prepared coffee-type drinks are at the commercial airliner, it is necessary to bring them on board and ready them for delivery to the individual air travelers who have placed orders. This can be accomplished in a number of different ways. Preferably, one or more multi-sectioned drink containers/carriers will be associated with a particular flight. Further, it is preferred that such multi-sectioned drink containers/carriers be adapted to be loaded onto a beverage/food cart of the type commonly used on commercial airliners. It is further possible to load prepared coffee-type drinks onto their own carts that are adapted to fit with an aisle of a commercial airliner, and which carts may themselves be brought directly onto the commercial airliner and utilized for purposes of distributing the prepared coffee-type drinks.

Where the air travelers have provided identifying information that includes seat assignments, or where the preparation facility 14 has itself been able to obtain such information by communication with the airliner, it would be preferred to load the prepared coffee-type drinks according to the row and seat assignment of the air travelers. (In this regard, where electronic communication is established between the preparation facility 14 and the commercial airline on which the air traveler is to travel, seat assignment information may be later obtained by the preparation facility 14 from the commercial airline after placement of the order by the air traveler, in those instances where the air traveler may not have yet received a seat assignment and thus may not have this information to provide.) This would ease service of the prepared coffee-type drinks to air travelers.

As the final step in the method, the prepared coffee-type drink is delivered by an in-flight service professional on the commercial airliner to each air traveler who has ordered such a product.

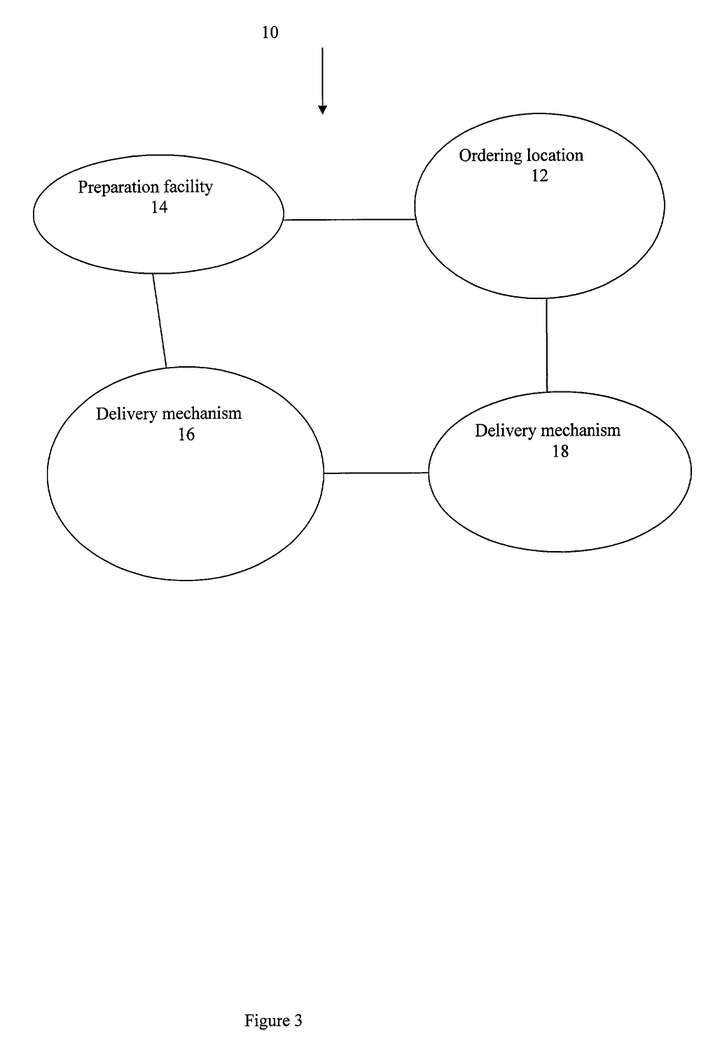

While a preferred embodiment of the present invention concerns the provision of an off-site prepared coffee-type drink to a commercial airliner, it should be understood that the present invention is intended to encompass the provision of other third-party originated items, following the placement of a pre-flight order by an air traveler, to an air traveler on a commercial airliner. For example, a meal prepared by a third-party vendor, such as a nationally-known restaurant chain, could be ordered by (and preferably paid for by) the air traveler in one of the manners discussed herein, prepared remote from the airliner, and delivered to the airliner prior to flight for subsequent delivery to the air traveler. Other commodities could also be ordered, paid for, and delivered according to the system and method described herein. For example, an air traveler could order and pay for books, magazines, newspapers, office supplies, clothing, stock quotes, or other items prior to boarding a commercial airliner, and have those items delivered on the commercial airliner. The system and method of the present invention, in a non-coffee-type drink embodiment, is generally illustrated in FIGS. 3-4, utilizing equivalent reference numbers to describe equivalent features to those described in FIGS. 1-2.

It should be further understood that, while it is preferred that the coffee-type drink or other item be delivered to the air traveler at his or her seat, it would also be possible for these to be delivered to the air traveler prior to boarding the commercial airliner. In this embodiment, the ordered drink or other item would be delivered to the gate from where the commercial airliner is to depart, and there provided to the air traveler prior to or at the time of boarding of the airliner. In this embodiment, the delivery of the item to the air traveler at the commercial airliner is intended to include either delivery on the airliner (preferably to the air traveler in his or her seat) or proximate the airliner (such as at the gate).

While the invention has been particularly shown and described with reference to preferred embodiments thereof, it will be understood by those skilled in the art that the foregoing and other changes in form and details may be made therein without departing from the spirit and scope of the invention.

I claim:

1. A method for providing a coffee-type drink to an air traveler on a commercial airliner comprising the steps of:
an air traveler, prior to boarding a commercial airliner, ordering a coffee-type drink from an ordering location;
said air traveler providing to said ordering location identifying information regarding said air traveler;
communicating said order for said coffee-type drink to a remote coffee-type drink preparation facility;
preparing said coffee-type drink in accordance with said order at said coffee-type drink preparation facility;
applying said identifying information to said coffee-type drink;
delivering said coffee-type drink from said preparation facility to said commercial airliner; and
delivering said coffee-type drink to said air traveler at said commercial airliner.

2. The method of claim 1 wherein said ordering location is at said coffee-type drink preparation facility.

3. The method of claim 1 wherein said ordering location is remote from said coffee-type drink preparation facility.

4. The method of claim 3 wherein said ordering location is a stand located in an airport terminal.

5. The method of claim 3 wherein said ordering location is a kiosk located in an airport terminal.

6. The method of claim 5 wherein said kiosk has a computing device located therein and adapted to receive said order from said air traveler and to communicate said order to said preparation facility.

7. The method of claim 3 wherein said ordering location is an individual positioned within in an airport terminal.

8. The method of claim 3 wherein said ordering location is a web-site.

9. The method of claim 8 wherein said web-site is operated by said coffee-type drink preparation facility.

10. The method of claim 3 wherein said ordering location is provided by a commercial airline.

11. The method of claim 1 wherein said identifying information includes a name of said air traveler.

12. The method of claim 11 wherein said identifying information further includes an airline on which said air traveler is to travel.

13. The method of claim 12 wherein said identifying information further includes a number of a flight on which said air traveler is to travel.

14. The method of claim 13 wherein said identifying information further includes a number of a gate from which said commercial airliner is to depart.

15. The method of claim 14 wherein said identifying information further includes a seat assignment for said air traveler.

16. The method of claim 15 further comprising the step of said commercial airline communicating said seat assignment to said ordering location.

17. The method of claim 1 wherein said preparation facility is located in an airport from which said commercial airliner on which said air traveler is travelling.

18. The method of claim 17 wherein said preparation facility is a coffee shop that serves walk-up customers.

19. The method of claim 17 wherein said preparation facility is a production facility that does not serve walk-up customers.

20. The method of claim 1 wherein said step of applying said identifying information to said coffee-type drink comprises the step of placing said identifying information on a container containing said coffee-type drink.

21. The method of claim 1 wherein said step of applying said identifying information to said coffee-type drink comprises the step of placing said identifying information on a portion of a carrier adapted to carry a plurality of coffee-type drinks and placing said coffee-type drink proximate said identifying information.

22. The method of claim 1 further comprising the step of said air traveler making payment to said ordering location for said coffee-type drink.

23. The method of claim 1 wherein said step of delivering said coffee-type drink from said preparation facility to said commercial airliner further comprises the step of placing said coffee-type drink in a carrier adapted to carry a plurality of coffee-type drinks and delivering said carrier to said commercial airliner with said coffee-type drink contained therein.

24. The method of claim 23 wherein said carrier corresponds to a particular flight number of said commercial airliner.

25. The method of claim 23 wherein said carrier corresponds to a single gate within an airport terminal.

26. The method of claim 23 wherein said carrier corresponds to a commercial airline.

27. The method of claim 23 wherein said carrier is dimensioned to be loaded onto a wheeled airline service cart.

28. The method of claim 23 wherein said carrier is wheeled and is dimensioned to fit in an aisle of said commercial airliner.

29. A coffee-drink preparation and delivery system comprising, in combination:
a coffee-type drink preparation facility;
wherein said coffee-type drink preparation facility is remote from a commercial airliner;
an ordering location where an air traveler can order a coffee-type drink prior to boarding said commercial airliner and provide identifying information regarding said air traveler;
wherein said ordering location and said preparation facility are in communication with one another;
a first delivery mechanism for delivering coffee-type drink prepared at said preparation facility to said commercial airliner; and
a second delivery mechanism for delivering said coffee-type drink prepared at said preparation facility and delivered to said commercial airliner to said air traveler.

30. The system of claim 29 wherein said ordering location is at said coffee-type drink preparation facility.

31. The system of claim 29 wherein said ordering location is remote from said coffee-type drink preparation facility.

32. The system of claim 31 wherein said ordering location is a stand located in an airport terminal.

33. The system of claim 31 wherein said ordering location is a kiosk located in an airport terminal.

34. The system of claim 33 wherein said kiosk has a computing device located therein and adapted to receive said order from said air traveler and to communicate said order to said preparation facility.

35. The system of claim 31 wherein said ordering location is an individual positioned within in an airport terminal.

36. The system of claim 31 wherein said ordering location is a web-site.

37. The system of claim 36 wherein said web-site is operated by said coffee-type drink preparation facility.

38. The system of claim 31 wherein said ordering location is provided by a commercial airline.

39. The system of claim 29 wherein said identifying information includes a name of said air traveler.

40. The system of claim 39 wherein said identifying information further includes an airline on which said air traveler is to travel.

41. The system of claim 40 wherein said identifying information further includes a number of a flight on which said air traveler is to travel.

42. The system of claim 41 wherein said identifying information further includes a number of a gate from which said commercial airliner is to depart.

43. The system of claim 42 wherein said identifying information further includes a seat assignment for said air traveler.

44. The system of claim 29 wherein said preparation facility is located in an airport from which said commercial airliner on which said air traveler is travelling.

45. The system of claim 44 wherein said preparation facility is a coffee shop that serves walk-up customers.

46. The system of claim 44 wherein said preparation facility is a production facility that does not serve walk-up customers.

47. The system of claim 44 wherein said ordering facility is adapted to accept payment from said air traveler for said coffee-type drink.

48. The system of claim 29 further comprising a carrier adapted to carry a plurality of coffee-type drinks from said preparation facility to said commercial airliner.

49. The system of claim 48 wherein said carrier corresponds to a particular flight number of said commercial airliner.

49. The system of claim 48 wherein said carrier corresponds to a single gate within an airport terminal.

50. The system of claim 48 wherein said carrier corresponds to a commercial airline.

51. The system of claim 48 wherein said carrier is dimensioned to be loaded onto a wheeled airline service cart.

52. The system of claim 48 wherein said carrier is wheeled and is dimensioned to fit in an aisle of a commercial airliner.

53. A method for providing a third-party originating item to an air traveler on a commercial airliner comprising the steps of:
an air traveler, prior to boarding a commercial airliner, ordering a third-party originating item from an ordering location;
said air traveler providing to said ordering location identifying information regarding said air traveler;
communicating said order for said third-party originating item to a remote third-party originating item preparation facility;
providing said third-party originating item in accordance with said order at said preparation facility;
applying said identifying information to said third-party originating item;
delivering said third-party originating item from said preparation facility to said commercial airliner; and
delivering said third-party originating item to said air traveler at said commercial airliner.

54. The method of claim 53 wherein said ordering location is at said third-party originating item preparation facility.

55. The method of claim 53 wherein said ordering location is remote from said third-party originating item preparation facility.

56. The method of claim 55 wherein said ordering location is a stand located in an airport terminal.

57. The method of claim 55 wherein said ordering location is a kiosk located in an airport terminal.

58. The method of claim 57 wherein said kiosk has a computing device located therein and adapted to receive said order from said air traveler and to communicate said order to said preparation facility.

59. The method of claim 55 wherein said ordering location is an individual positioned within in an airport terminal.

60. The method of claim 55 wherein said ordering location is a web-site.

61. The method of claim 60 wherein said web-site is operated by said third-party originating item preparation facility.

62. The method of claim 55 wherein said ordering location is provided by a commercial airline.

63. The method of claim 53 wherein said identifying information includes a name of said air traveler.

64. The method of claim 63 wherein said identifying information further includes an airline on which said air traveler is to travel.

65. The method of claim 64 wherein said identifying information further includes a number of a flight on which said air traveler is to travel.

66. The method of claim 65 wherein said identifying information further includes a number of a gate from which said commercial airliner is to depart.

67. The method of claim 66 wherein said identifying information further includes a seat assignment for said air traveler.

68. The method of claim 67 further comprising the step of said commercial airline communicating said seat assignment to said ordering location.

69. The method of claim 53 wherein said preparation facility is located in an airport from which said commercial airliner on which said air traveler is travelling.

70. The method of claim 53 further comprising the step of said air traveler making payment to said ordering location for said third-party originating item.
